(19) United States
(12) Patent Application Publication
(10) Pub. No.: US 2010/0026642 A1
(43) Pub. Date: Feb. 4, 2010

(54) User interface apparatus and method using pattern recognition in handy terminal

(75) Inventors: Nam-Ung Kim, Seoul (KR); Suk-Soon Kim, Suwon-si (KR); Seong-Eun Kim, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/462,232

(22) Filed: Jul. 30, 2009

(30) Foreign Application Priority Data
Jul. 31, 2008 (KR) 10-2008-0075111

(51) Int. Cl. G06F 3/041

(52) U.S. Cl. 345/173

(57) ABSTRACT

A user interface apparatus and method using pattern recognition in a handy terminal with a touch screen. The apparatus and method includes receiving a specific pattern drawn on the touch screen by a user and a specific command written in a region defined by the specific pattern, and performing a function associated with a combination of the specific pattern and command when the received specific pattern and command are a valid pattern and command.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Jul. 31, 2008 and assigned Serial No. 10-2008-0075111, the entire disclosure of which is hereby incorporated by reference.

### TECHNICAL FIELD OF THE INVENTION

The present invention relates to a user interface apparatus and method that uses a pattern recognition technology to implement command inputting in a more efficient and simplified manner in a handy terminal with a touch screen.

### BACKGROUND OF THE INVENTION

As digital handy terminals have been popularized and support high performance as information processing devices, a variety of methods for processing user input information have been proposed. These methods allow users to more easily make use of functions of a phonebook, a short message composer, an electronic scheduler, etc., realized in digital handy terminals. One of such methods is an input method based on a touch screen (or a touch panel). The touch screen technique, due to the convenience of its user interface, is popularly used when functions of a phonebook, a scheduler, a short message composer, a personal information manager, Internet access, an electronic dictionary, etc., are performed in a Personal Digital Assistant (PDA), a smart phone combined with a mobile phone, an Internet phone, and the like. At present, a contact-type capacitive technique or resistive technique is most widely used in the handy terminal with a touch screen.

The touch screen provides a new type of user interface device, and inputs a command or graphic information designated by a user by generating a voltage or current signal in a position where a stylus pen or a finger is pushed. The touch screen technique can be realized using a character recognition function proposed with the development of a pattern recognition technology and software supporting the same, and its use is increasing because the user can conveniently input desired information using a naturally-used input means such as a pen and a finger.

In particular, the touch screen is assessed as the most ideal input method under a Graphical User Interface (GUI) environment because the user can directly carry out a desired work while viewing the screen, and can easily handle the touch screen.

Currently, the pattern recognition technology capable of recognizing letters and graphics on the touch screen, supports functions of OK, Previous Page, Next Page, Del, Save, Load, Cancel, etc., using a simple stroke function. Further, the pattern recognition technology may implement abbreviated commands by bundling a set of commands. However, the stroke-based technology has a restriction due to its limited commands and realization methods. That is, this technology should memorize shapes of stroke functions individually, and may lack additional functions needed by the user. Besides, bundling a set of commands may reduce the user's convenience. Therefore, there is a long-felt need for an apparatus and method capable of more efficiently and simply implementing a user interface in a handy terminal with a touch screen.

### SUMMARY OF THE INVENTION

To address the above-discussed deficiencies of the prior art, it is a primary object to provide at least the advantages described below. Accordingly, an aspect of the present invention provides a user interface apparatus and method for inputting and executing a command on a touch screen using a pattern recognition technology for more efficient and simplified user interface in a handy terminal.

Another aspect of the present invention provides a user interface apparatus and method for simplifying and dividing pattern recognition-based commands into execution commands and move commands based on user's convenience, and designating commands associated therewith.

A further another aspect of the present invention provides a user interface apparatus and method for enabling a user to delete or cancel the wrong content that is input on a touch screen in a simple and convenient manner.

According to one aspect of the present invention, there is provided a user interface method for a handy terminal with a touch screen. The user interface method includes receiving a specific pattern drawn on the touch screen by a user and a specific command written in a region defined by the specific pattern; and performing a function associated with a combination of the specific pattern and command when the received specific pattern and command are a valid pattern and command.

According to another aspect of the present invention, there is provided a user interface apparatus for a handy terminal with a touch screen. The user interface apparatus includes an input/output unit with the touch screen for receiving a specific pattern or a specific command through the touch screen and outputting a current input state and an operation execution result; and a controller for receiving a specific pattern drawn on the touch screen and a specific command written in a region defined by the specific pattern through the input/output unit, and controlling an operation of the handy terminal to perform a function associated with a combination of the specific pattern and command when the received specific pattern and command are a valid pattern and command.

According to a further another aspect of the present invention, there is provided a user interface method for a handy terminal with a touch screen. The user interface method includes receiving information through the touch screen; displaying the received information on the touch screen; and deleting the information displayed on the touch screen upon sensing shaking of the handy terminal by the user.

According to yet another aspect of the present invention, there is provided a user interface apparatus for a handy terminal with a touch screen. The user interface apparatus includes an input/output unit for receiving information through the touch screen and displaying the received information on the touch screen; a gyro sensor for sensing shaking of the handy terminal by a user; and a controller for controlling the input/output unit to delete the information displayed on the touch screen when the shaking of the handy terminal is sensed by the gyro sensor.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a handy terminal according to an embodiment of the present invention;

FIG. 2 illustrates a structure of a handy terminal according to another embodiment of the present invention;

FIG. 3 illustrates a control flow according to an embodiment of the present invention;

FIG. 4 illustrates a control flow for the function registration subroutine in FIG. 3;

FIG. 5 illustrates a control flow for the function execution subroutine in FIG. 3;

FIG. 6 illustrates a method of inputting a command on a touch screen by a user according to an embodiment of the present invention;

FIGS. 7A and 7B illustrate an exemplary operation of executing an execution command according to an embodiment of the present invention;

FIGS. 8A and 8B illustrate an exemplary operation of executing a move command according to an embodiment of the present invention;

FIGS. 9A and 9B illustrate exemplary operations of performing a delete function according to an embodiment of the present invention; and

FIGS. 10A to 10C illustrate exemplary operations of performing a cancel function according to an embodiment of the present invention.

Throughout the drawings, the same drawing reference numerals will be understood to refer to the same elements, features and structures.

### DETAILED DESCRIPTION OF THE INVENTION

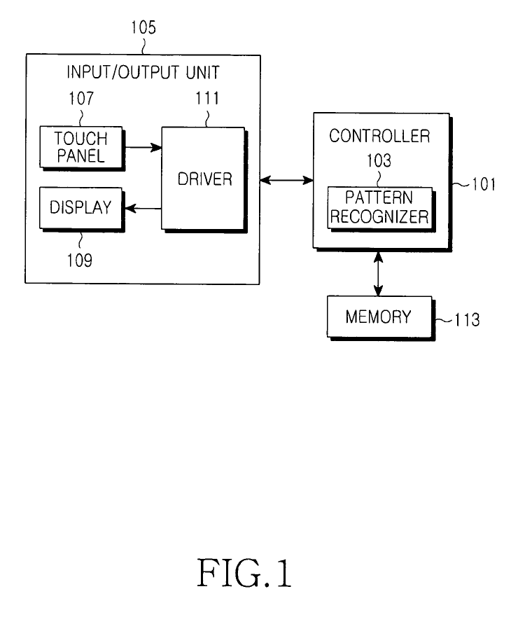

FIGS. 1 through 10C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication device.

The present invention provides a user interface apparatus and method that uses a pattern recognition technology to implement command inputting in a more efficient and simplified manner in a handy terminal with a touch screen.

Although a mobile communication terminal will be considered in the following detailed description of the present invention, the apparatus and method proposed by the present invention can be applied even to handy terminals with a touch screen.

Embodiments of the present invention will be described in detail below with reference to the accompanying drawings.

FIG. 1 illustrates a structure of a handy terminal according to a first embodiment of the present invention. Referring to FIG. 1, the handy terminal can be roughly divided into a controller 101, an input/output unit 105, and a memory 113. The controller 101 may include a pattern recognizer 103, and the input/output unit 105 may include a touch panel 107, a display 109, and a driver 111.

In the following description, operations of the above devices, which have nothing to do with the present invention, will not be described.

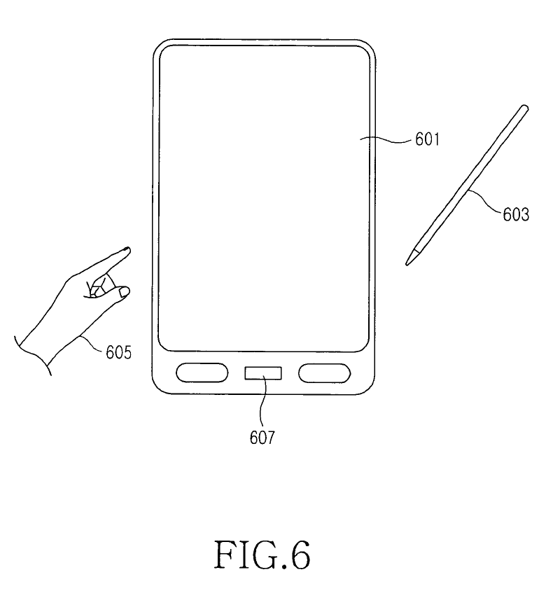

A user can enter a user interface mode at a time in which patterns are recognized by pushing a function key or hot key 607 (see FIG. 6) on a mobile communication terminal, and can use it in association with the existing user interface.

When the user enters the user interface mode for pattern recognition, the user can input a specific pattern and a specific command on the touch panel 107 (or touch screen) using a stylus pen or a finger. In the present invention, a pattern to be used as a command input window may be a graphic or a symbol, and the content entered in the graphic or symbol becomes a command. The command is generally expressed in letters.

The touch panel 107 receives the pattern from the user, and outputs touch panel data. Here, the touch panel data is composed of resources of spatial coordinate data and stroke data indicating a stroke count of a pertinent letter, both data being needed by the controller 101 in recognizing the pattern.

The display 109 displays the content currently input on the touch screen and the command execution result by the present invention. The driver 111 converts an analog signal output from the touch panel 107 into digital touch panel data, and outputs the digital touch panel data to the controller 101. Further, the driver 111 performs an operation of converting a digital signal output from the controller 101 into an analog signal and outputting the analog signal to the display 109, or performs an operation of delivering the content that the user currently inputs on the touch screen to the display 109 so that the user may check the content.

The controller 101 recognizes a pattern and a command, which the user inputs on the touch screen (or touch panel 107), and performs an operation registered in the memory 113. To be specific, when a command pattern is input on the touch panel 107 by the user, the controller 101 receives digital touch panel data from the driver 111.

The controller 101 provides the received touch panel data to the pattern recognizer 103 to determine whether the input pattern or command is a letter or a symbol (or graphic).

The pattern recognizer 103 in the controller 101 calculates and reads accurate coordinate data and stroke data of a letter or a symbol which is input on the touch panel 107 according to a pattern recognition program that was previously coded in a program, and performs a recognition operation on the letter or symbol by recognizing the read data as the letter or symbol. The recognized letter or symbol is stored in the memory 113 in a code (or sequence). The pattern recognizer 103 can distinguish a symbol (or graphic) from a letter generated in the process recognizing the graphic based on a size of the graphic. That is, if a size of the pattern is greater than or equal to a specific size, the pattern recognizer 103 recognizes the pattern not as a letter, but as a graphic or symbol to be used as a command input window.

The controller 101 selects a pattern identical to a preset pattern previously stored in the memory 113 from among the patterns output from the pattern recognizer 103, and then determines an operation command associated with the selected pattern.

For example, in an embodiment of the present invention, rectangular and diamond-shaped patterns are used as graphics to be used as command input windows, and the contents entered in these graphics become commands. It is assumed that the rectangle represents an execution command while the diamond indicates a move command. The command input window is subject to change in shape, and the user may arbitrarily set a new command through function setting.

Therefore, when the user inputs a rectangle greater than or equal to a specific size on the touch screen using a stylus pen, the pattern recognizer 103 recognizes the rectangle not as a letter but as a graphic. The pattern recognizer 103 provides shape information of the input pattern to the controller 101. The controller 101 determines if the input pattern is identical to the preset pattern registered in the memory 113 based on the information provided from the pattern recognizer 103.

If the pattern input on the touch panel 107 by the user is not a valid pattern registered in the memory 113, the controller 101 requests the user to re-input a new pattern without performing any operation. However, if the input pattern is a valid pattern, the controller 101 determines an operation command associated with the input pattern. As assumed above, in the present invention, when a rectangle is input as a command input window, the controller 101 recognizes the rectangle as an execution command window, and when a diamond is input as a command input window, the controller 101 recognizes the diamond as a move command window.

The memory 113 initially stores preset patterns and commands, and the user may additionally store necessary functions and operations during function registration by defining new patterns and commands.

Table 1 below shows a memory table according to an embodiment of the present invention. Table 1 gives a mere example of the patterns and commands stored in the memory 113, and new patterns, commands and functions may be freely defined and added by the user at anytime.

TABLE 1

| Patterns | Commands | Functions |
|---|---|---|
| 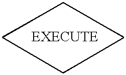 | C S V B X | Call sending SMS (MMS) delivery Change from bell to vibration Change from vibration to bell Power off |
| 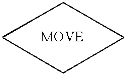 | V P A M C N CL S | Move to Vocabulary menu Move to Phonebook menu Move to Alarm menu Move to MP3 menu Move to Camera menu Move to Notepad menu Move to Calculator menu Move to Setting window |
| . . . | . . . | . . . |

The user inputs a command input window (rectangle, diamond, etc) on the touch screen (or touch panel) with a stylus pen, and then inputs a specific command in the command input window. The touch panel data, which is input through the touch panel 107, is converted from an analog signal into a digital signal by the driver 111 and then provided to the controller 101. The pattern recognizer 103 in the controller 101 recognizes the input command by receiving the touch panel data. The pattern recognizer 103 provides shape information of the input command to the controller 101. The controller 101 determines if the input command is identical to the command registered in the memory 113 based on the information provided from the pattern recognizer 103. If the command input on the touch panel 107 by the user is not a valid command registered in the memory 113, the controller generates an error message without performing any operation. However, if the input command is a valid command, the controller 101 determines a function associated with the input command.

If an execution operation is input by the user after the pattern and command inputting by the user is completed, the controller 101 performs an operation that is registered in the memory 113 in association with the input pattern and command.

In an embodiment of the present invention, a method of executing the operation through the touch screen includes inputting the command input window (pattern) and the command with a stylus pen, and then pushing the input section (or region) with a finger. The operation of inputting a command and the operation of executing the input command can be distinguished based on the input method. That is, whether the input corresponds to command inputting or command execution can be determined based on the push area specified by an input tool.

However, it is obvious to those skilled in the art that another method of executing an operation may include, for example, double-stroking the input section with a stylus pen or the like.

The touch screen of the present invention can distinguish an input by a finger from an input by a stylus pen using a touchpad sensor technology based on the resistive touch screen technique. In the resistive touch screen technique, a potential difference occurs in a contact point when a touch is made on an upper plate and a lower plate, over which a constant voltage is applied, and a controller detects the touched section by sensing the potential difference. Therefore, when a touch is made on the resistive touch screen, it is possible to distinguish an input by the finger from an input by the stylus pen depending on the touched area.

With the use of the handy terminal according to an embodiment of the present invention, it is possible to overcome the restriction caused by limited commands and realization methods, and to implement a user interface in a more efficient and simplified manner.

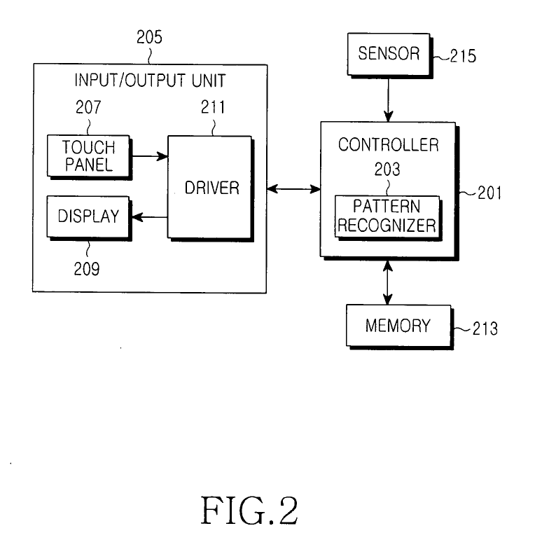

FIG. 2 illustrates a structure of a handy terminal according to a second embodiment of the present invention.

Referring to FIG. 2, a user interface device capable of deleting the content input on the touch panel (or a touch screen 207) or canceling a command input window on the touch panel by further providing a sensor 215 in addition to a controller 201, a pattern recognizer 203, a memory 213, an input/output unit 205, a display 209, and a driver 211 similar to those illustrated in FIG. 1.

Although the present invention uses a gyro sensor as the sensor 215, it is also possible to use other sensor devices having a similar function. When a user has wrongly input content on the touch screen or desires to cancel the input content, the user may delete or cancel the content input on the touch screen by shaking the handy terminal left/right or up/down.

If the user sakes the handy terminal at or over a specific strength after content is input on the touch screen, the gyro sensor 215 senses the shaking and generates an electric signal. The controller 201 performs full deletion or command input window cancellation by receiving the electric signal from the gyro sensor 215.

The input/output unit 205 deletes the currently-displayed full screen or cancels the displayed command input window under the control of the controller 201.

Therefore, the user interface device provided by the present invention can simply delete or cancel the content or command input window wrongly input on the touch screen by shaking the handy terminal without taking a separate complicated operation.

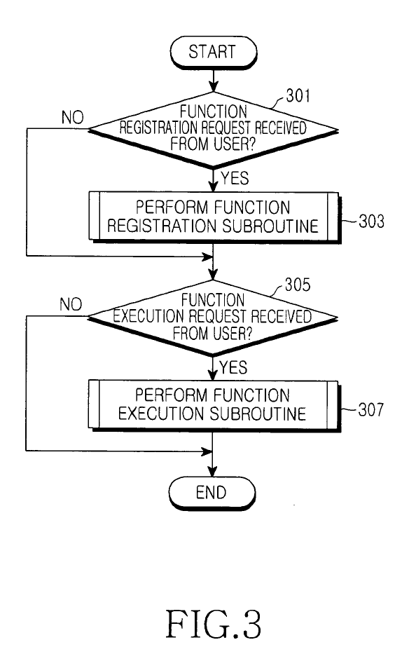

FIG. 3 illustrates a control flow of a user interface method according to the first embodiment of the present invention. Generally, the user interface method described below is performed by the controller.

Referring to FIG. 3, the controller determines in step 301 whether a function registration request according to the present invention is received from a user. If there is no function registration request from the user, the controller determines in step 305 whether a function execution request according to the present invention is received from the user. If neither the function registration request nor the function execution request is received from the user, the controller ends the procedure according to the present invention.

If there is a function registration request from the user, the controller performs a function registration subroutine in step 303. The function registration subroutine will be described in detail below.

Meanwhile, if there is no function execution request from the user, the controller terminates the procedure. However, if there is a function execution request from the user, the controller performs a function execution subroutine in step 307. The function execution subroutine will be described in detail below.

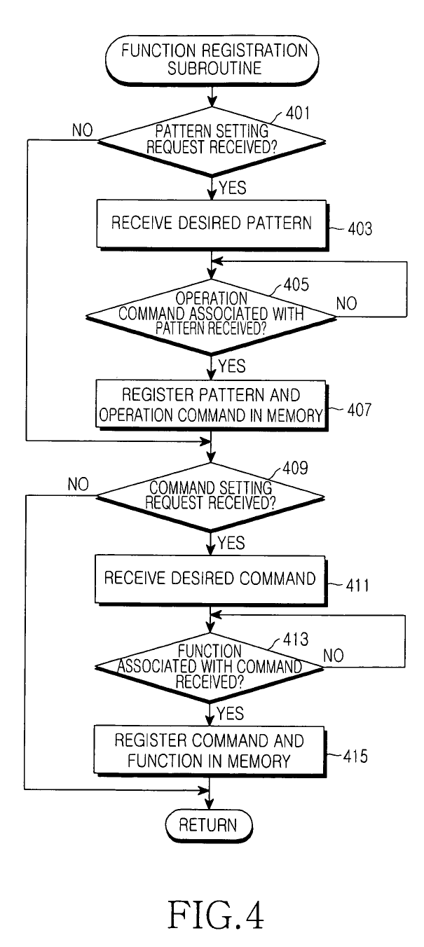

FIG. 4 illustrates a detailed control flow for the function registration subroutine in FIG. 3.

Referring to FIG. 4, the controller determines in step 401 whether a setting request for a pattern to be used as a command input window is received from the user. If a setting request for a pattern is received from the user, the controller receives a pattern that the user intends to set in step 403. The pattern being input by the user can be a preset graphic or symbol. If needed, the user may arbitrarily set the pattern by directly drawing a pattern on the touch screen with a stylus pen. After the pattern inputting, the controller determines in step 405 whether an operation command associated with the input pattern, i.e., an execution command or a move command, is input.

If no operation command is input, the controller returns to step 405, and if an operation command is input, the controller proceeds to step 407. Also, regarding the operation command associated with the pattern, the user may select one of preset commands, or arbitrarily set a new command. In a preferred embodiment of the present invention, as an example of the pattern, a rectangle is defined as an execution command window and a diamond is defined as a move command window.

In step 407, if an operation command associated with the pattern is determined, the controller registers the input pattern and operation command in a memory. After step 407 or if no setting request for a pattern is input by the user in step 401, the controller proceeds to step 409.

In step 409, the controller determines if a setting request for a command to be entered in a pattern to be used as the command input window is input by the user. If there is no command setting request from the user, the controller ends the function registration subroutine. However, if there is a command setting request from the user, the controller receives a command that the user desires to set in step 411. Regarding the command, the user may select preset content, or additionally set a new command. After the command inputting, the controller proceeds to step 413.

In step 413, the controller determines if a function associated with the command, e.g., Call (or C) indicating ‘Call sending’ and Voc (or V) indicating ‘Move to Vocabulary menu’, is input. If the function is not input, the controller returns to step 413. If the function inputting is completed, the controller proceeds to step 415. Also, regarding the function associated with the command, the user may select one of the preset functions, or arbitrarily set a new function.

After the command and function inputting by the user is completed, the controller registers in the memory the command and its associated function, which are input by the user, in step 415. When the registration in the memory is completed, the function registration subroutine is ended.

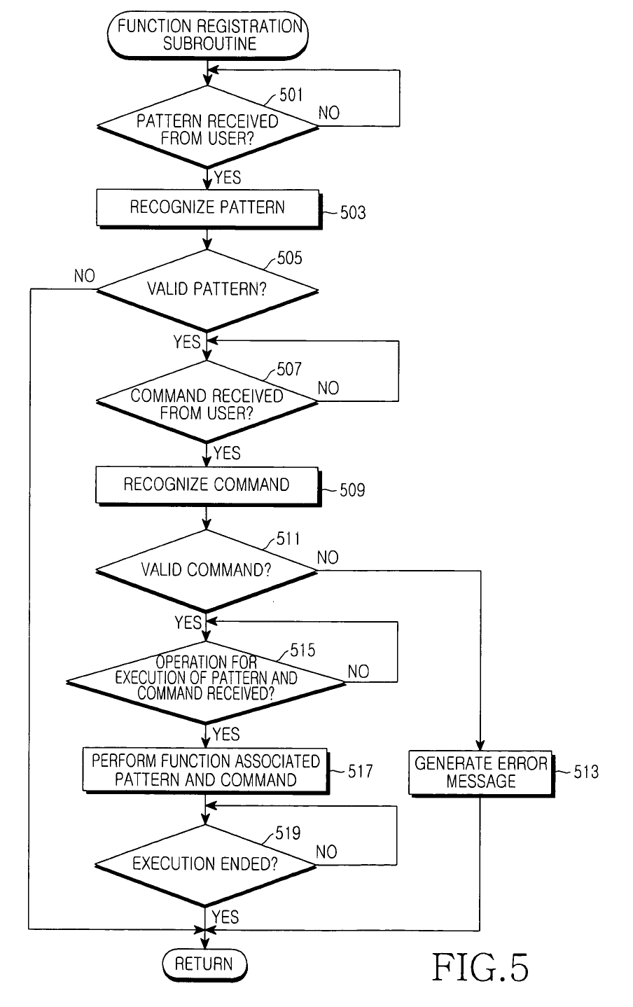

FIG. 5 illustrates a detailed control flow for the function execution subroutine in FIG. 3.

Referring to FIG. 5, the controller determines in step 501 whether a specific command pattern is input by the user. If the command pattern is input by the user, the controller recognizes a shape of the input pattern using a pattern recognizer in step 503.

Thereafter, the controller determines in step 505 whether the input pattern is a valid pattern by recognizing the input pattern and then comparing it with a pattern registered in the memory. If the input pattern is not a valid pattern, the controller ends the function execution subroutine, and requests the user to input a new command pattern. However, if the input pattern is a valid pattern, the controller proceeds to step 507.

In step 507, the controller determines if a command to be entered in the pattern is input by the user. If the command inputting is completed, the controller recognizes the input command using the pattern recognizer in step 509.

Thereafter, the controller determines in step 511 whether the recognized command is a valid command by comparing the recognized command with a command registered in the memory. If the recognized command is not a valid command, the controller generates an error message indicating invalidity of the input command in step 513. However, if the recognized command is a valid command, the controller proceeds to step 515.

In step 515, the controller determines if an operation of executing the input pattern and command is input by the user. As described above, the execution operation may include pushing the input pattern section on the touch screen with a finger, or stroking the input pattern section with a stylus pen. That is, the execution operation can be implemented by any input operation differentiated from the above input operation.

If the execution operation is input by the user, the controller proceeds to step 517.

In step 517, the controller performs the function or operation that is registered in the memory in association with the pattern and command input by the user. After step 517, the controller determines in step 519 whether the function execution is completed. If the function execution is completed, the controller ends the function execution subroutine.

With use of the handy terminal to which the novel user interface method is applied, it is possible to overcome the restriction caused by the limited commands and realization methods, and to implement a user interface in a more efficient and simplified manner.

In addition, for example, an application capable of displaying a virtual calculator on the touch screen is also available, thus making it possible to make user-desired applications.

Exemplary operations according to an embodiment of the present invention will now be described in detail with reference to the accompanying drawings.

FIG. 6 illustrates a method of inputting a command on a touch screen by a user according to an embodiment of the present invention.

Referring to FIG. 6, a method of inputting a specific pattern or command on a touch screen 601 by a user can be divided into a method using a finger 605 and a method using a stylus pen 603. In an exemplary operation described below, the pattern and command desired by the user are input with the stylus pen 603, and the execution operation is input by pushing the input pattern section on the touch screen 601 with the finger 605.

As described above, it is obvious to those skilled in the art that the input method may be implemented using any one of the finger and the stylus pen. The input method can also be implemented using other tools excluding the finger and the stylus pen.

A function key or hot key 607 on the lower part of the handy terminal, shown in FIG. 6, is provided to enter the user interface mode for pattern recognition, and can be used in association with the existing user interface.

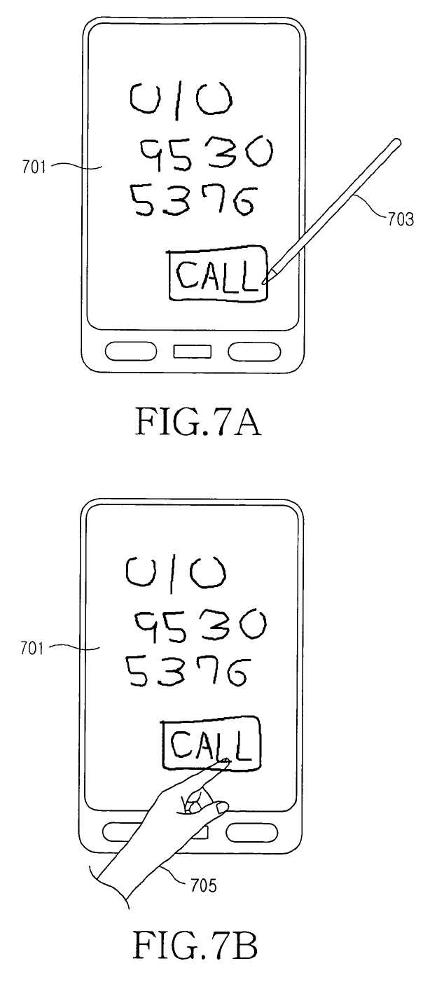

FIGS. 7A and 7B illustrate exemplary operations of executing an execution command (e.g., Call) according to an embodiment of the present invention.

Referring to FIGS. 7A and 7B, a user writes a desired phone number on a touch screen 701 with a stylus pen 703. Thereafter, the user draws a rectangular pattern indicating an execution command in a space on the touch screen 701 with the stylus pen 703, and then writes therein a command “CALL” or its abbreviation “C”.

After completion of the pattern and command inputting, the user executes a Call operation by pushing the rectangular section with “CALL” displayed in it, using his/her finger 705.

Although only the Call operation is considered in the above example, execution commands such as Short Message Service (SMS) or Multimedia Messaging Service (MMS) Delivery, Bell-to-Vibration Change, Vibration-to-Bell Change, Power Off, etc., can also be performed, and the user may freely define and add other functions.

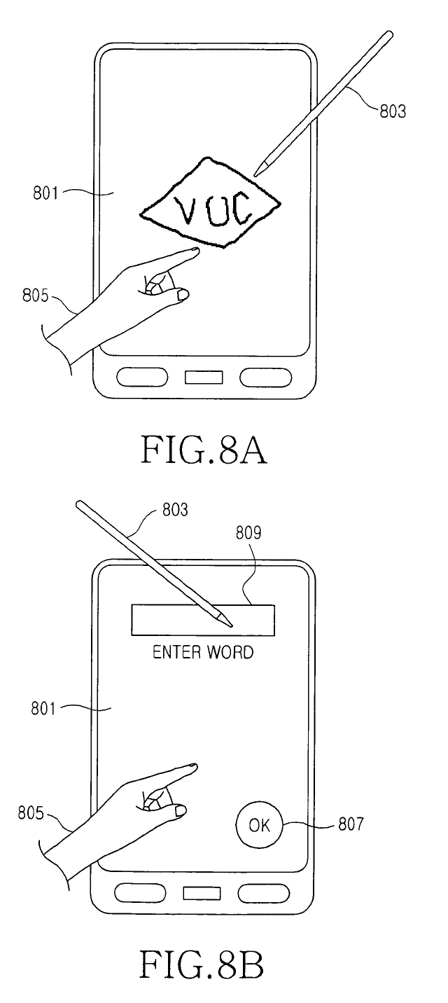

FIGS. 8A and 8B illustrate exemplary operations of executing a move command according to an embodiment of the present invention.

Referring to FIGS. 8A and 8B, a user draws a diamond on a touch screen 801 with a stylus pen 803, and then writes therein an abbreviation “VOC” of a menu to which the user intends to move. The diamond is a pattern meaning a move command, and the abbreviation “VOC” of the menu is a command. If the user pushes the diamond section using his/her finger 805, the handy terminal moves to an English vocabulary search window 809. If the user enters a desired English word in the English vocabulary search window 809 with the stylus pen 803 and pushes an OK button 807 with the finger 805 or the stylus pen 803, the handy terminal searches for the desired English word.

Although a “Move-to-Dictionary menu” function is considered in the above example, move commands such as Move-to-Phonebook window (P), Move-to-Alarm window (A), Move-to-MP3 window (M), Move-to-Camera window (C), Move-to-Notepad window (N), Move-to-Calculator window (CL), Move-to-Setting window (S), etc., can also be performed, and the user may define and add new functions.

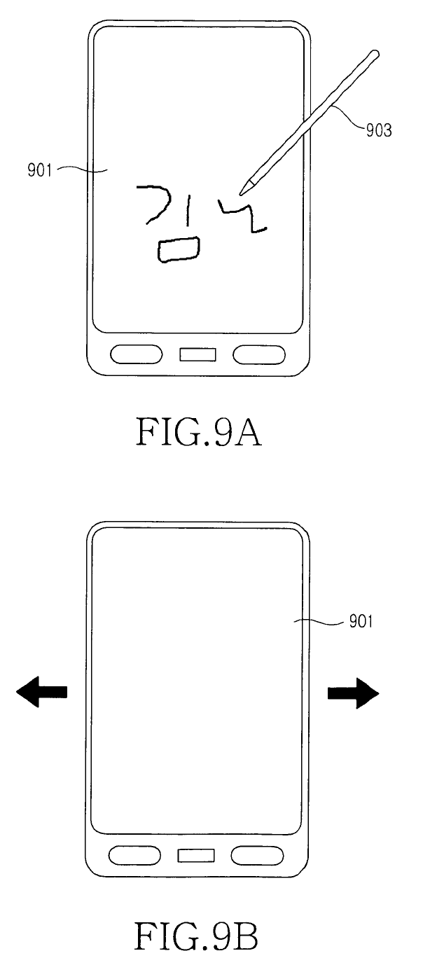

FIGS. 9A and 9B illustrate exemplary operations of performing a delete function according to an embodiment of the present invention.

Referring to FIGS. 9A and 9B, if a user wrongly inputs a letter or a pattern on a touch screen 901 with a stylus pen 903, the user can delete the content input on the touch screen 901 by simply shaking the mobile communication terminal up/down, left/right, or back/forth without performing separate operations.

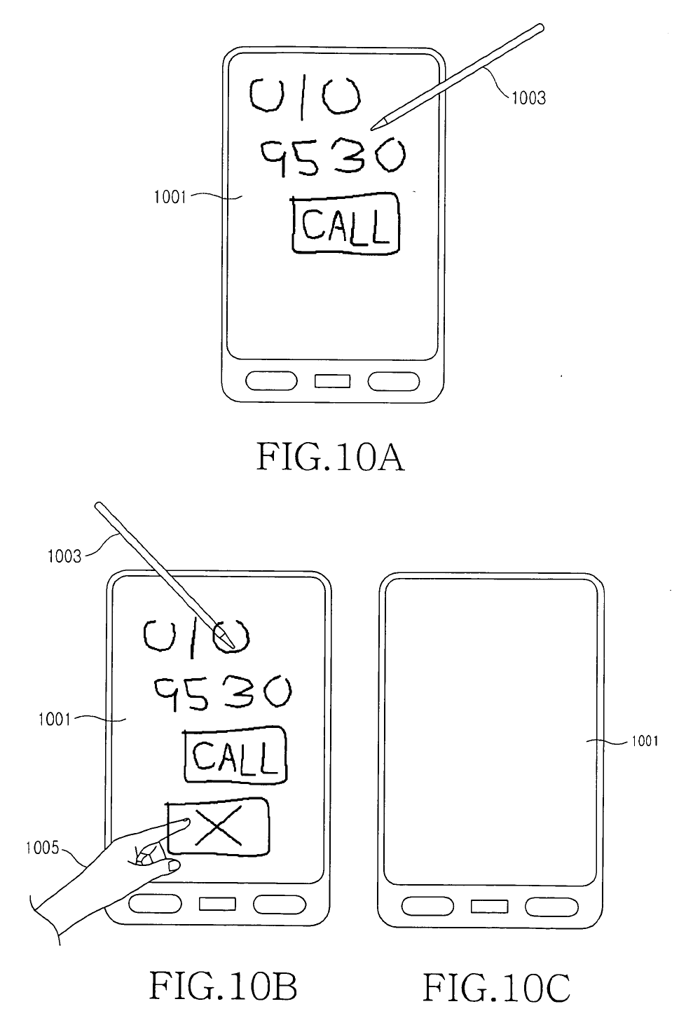

FIGS. 10A to 10C illustrate exemplary operations of performing a cancel function according to an embodiment of the present invention.

Referring to FIGS. 10A to 10C, if a user wrongly inputs a command input window (pattern) or a command on a touch screen 1001 with a stylus pen 1003, the user may cancel the input content rather than performing the above delete function.

The user re-draws the same pattern as the wrongly input command execution window in a space on the touch screen 1001 and then inputs an “X” mark therein using the stylus pen 1003. Thereafter, if the user pushes the “X”-marked command execution window with his/her finger 1005, the wrongly input command input window is cancelled. Regarding the “X” mark entered in the command input window, the user may arbitrarily set another mark.

As is apparent from the foregoing description, the present invention provides a sort of a haptic technique to be used as a key technology of the next-generation mobile communication terminal, and can apply increased commands for the user, and various changes in pattern and command are possible for user's convenience.

In addition, the present invention allows the user to add or change his/her desired functions, making a more appropriate user interface environment. Moreover, dynamic utilization of needed functions is possible without using the preset user interface. Further, various applications are applicable.

That is, exemplary application of a pattern recognition technology to a mobile communication terminal with a touch screen has been described with reference to embodiments of the present invention. However, those of ordinary skill in the art will recognize that the present invention can be applied to other handy terminals with a touch screen having the similar technical background, without departing from the scope and spirit of the invention.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user interface method for a handy terminal with a touch screen, comprising:
receiving a specific pattern drawn on the touch screen by a user and a specific command written in a region defined by the specific pattern; and
performing a function associated with a combination of the specific pattern and command when the received specific pattern and command are a valid pattern and command.

2. The user interface method of claim 1, further comprising determining that the received specific pattern and command are a valid pattern and command when the received specific pattern and command have been registered in a memory.

3. The user interface method of claim 1, wherein the receiving of a specific pattern and a specific command comprises receiving from the user a function execution request to perform a function associated with the specific pattern and command.

4. The user interface method of claim 1, wherein the specific pattern or command is input using a stylus pen.

5. The user interface method of claim 3, wherein the function execution request is input by a method differentiated from the method of receiving a specific pattern and a specific command.

6. The user interface method of claim 3, wherein the function execution request is input by pushing a region defined by the specific pattern with a finger by the user.

7. The user interface method of claim 1, further comprising registering in a memory the specific pattern or command and a function associated with the specific pattern or command upon receipt of a function registration request from the user.

8. The user interface method of claim 7, wherein the registration comprises:
receiving at least one of a specific pattern drawn on the touch screen by the user and a specific command;
selecting a function associated with the received specific pattern, the received specific command, or the received specific pattern and command; and
registering the received specific pattern, the received specific command, or the received specific pattern and command in the memory in association with the selected function.

9. The user interface method of claim 1, further comprising deleting the received specific pattern or the received specific command when the handy terminal is shook by the user after at least one of the specific pattern and the specific command is received.

10. The user interface method of claim 1, further comprising canceling the received specific pattern or the received specific command when a cancel pattern registered in a pattern associated with a cancel request is input on the touch screen by the user after at least one of the specific pattern and the specific command is received.

11. A user interface apparatus for a handy terminal with a touch screen, comprising:
an input/output unit associated with the touch screen for receiving a specific pattern or a specific command through the touch screen and outputting a current input state and an operation execution result; and
a controller for receiving a specific pattern drawn on the touch screen and a specific command written in a region defined by the specific pattern through the input/output unit, and controlling an operation of the handy terminal to perform a function associated with a combination of the specific pattern and command when the received specific pattern and command are a valid pattern and command.

12. The user interface apparatus of claim 11, further comprising a memory for storing information about a function associated with each of combinations of at least one pattern and at least one command;
wherein the controller determines that the received specific pattern and command are a valid pattern and command when the received specific pattern and command have been registered in the memory.

13. The user interface apparatus of claim 11, wherein the controller controls an operation of the handy terminal to perform a function associated with a combination of the specific pattern and command when a function execution request is provided from a user through the input/output unit.

14. The user interface apparatus of claim 11, wherein the specific pattern or command is input using a stylus pen.

15. The user interface apparatus of claim 13, wherein the function execution request is input by a method differentiated from the method of receiving a specific pattern and a specific command.

16. The user interface apparatus of claim 13, wherein the function execution request is input by pushing a region defined by the specific pattern with a finger by the user.

17. The user interface apparatus of claim 12, wherein the controller registers the specific pattern or command, and a function associated with the specific pattern or command in the memory upon receipt of a function registration request from the user.

18. The user interface apparatus of claim 17, wherein the controller includes:
receiving at least one of a specific pattern drawn on the touch screen by the user and a specific command through the input/output unit;
selecting a function associated with the received specific pattern, the received specific command, or the received specific pattern and command; and
registering the received specific pattern, the received specific command, or the received specific pattern and command in the memory in association with the selected function.

19. The user interface apparatus of claim 11, further comprising a gyro sensor for providing an electrical signal to the controller by sensing shaking of the handy terminal by the user;
wherein the controller deletes a specific pattern or a specific command displayed on the touch screen upon receiving the electrical signal.

20. The user interface apparatus of claim 11, wherein the controller instructs the input/output unit to cancel the received specific pattern or the received specific command when a cancel pattern associated with a cancel request is input by the user after at least one of the specific pattern and the specific command is received.

21. A user interface method for a handy terminal with a touch screen, comprising:
receiving information through the touch screen;
displaying the received information on the touch screen; and
deleting the information displayed on the touch screen upon sensing shaking of the handy terminal by the user.

22. A user interface apparatus for a handy terminal with a touch screen, comprising:
an input/output unit for receiving information through the touch screen and displaying the received information on the touch screen;
a gyro sensor for sensing shaking of the handy terminal by a user; and
a controller for controlling the input/output unit to delete the information displayed on the touch screen when the shaking of the handy terminal is sensed by the gyro sensor.
